(19) United States
(12) Patent Application Publication
(10) Pub. No.: US 2010/0104006 A1
(43) Pub. Date: Apr. 29, 2010

(54) REAL-TIME NETWORK VIDEO PROCESSING

(75) Inventors: John Richard Taylor, Tiburon, CA (US); Randy Yen-pang Chou, San Jose, CA (US); Joel Frederic Adam, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: PIXEL8 NETWORKS, INC., Menlo Park, CA (US)

(21) Appl. No.: 12/260,032

(22) Filed: Oct. 28, 2008

(51) Int. Cl. H04N 7/30

(52) U.S. Cl. 375/240.2; 375/E07.226

(57) ABSTRACT

An embodiment is a method and apparatus to process video frames. An entropy decoder performs entropy decoding on a bitstream of a video frame extracted from a network frame. The entropy decoder generates discrete cosine transform (DCT) coefficients representing a picture block in the video frame. The entropy decoder is configured for serial operations. A graphics processing unit (GPU) performs image decoding using the DCT coefficients. The GPU is configured for parallel operations.

One disclosed feature of the embodiments is a technique to decode a video frame. A GPU performs image encoding of a video frame computing quantized DCT coefficients representing a picture block in the video frame. The GPU is configured for parallel operations. An entropy encoder performs entropy encoding on the quantized DCT coefficients. The entropy encoder is configured for serial operations.

### TECHNICAL FIELD

The presently disclosed embodiments are directed to the field of computer networks, and more specifically, to network video processing.

### BACKGROUND

Network multimedia distribution and content delivery have become increasingly popular. Advances in network and media processing technologies have enabled media contents such as news, entertainment, sports, or even personal video clips to be downloaded or uploaded via the Internet for personal viewing. However, due to the large amount of video data, the delivery of video information via the networks still presents a number of challenges. Compression and decompression techniques have been developed to reduce the bandwidth requirements for video data. For example, Moving Picture Experts Group (MPEG) standards (e.g., MPEG-1, MPEG-2, MPEG-4) provide for compression and decompression formats for audio and video.

The compression and decompression of video streams typically include a series of operations that involve sequential and parallel tasks. Existing techniques to process video streams have a number of disadvantages. One technique uses processors that are optimized for parallel tasks to perform both types of operations. This technique incurs additional overhead to process sequential tasks. In addition, the performance may suffer because valuable parallel resources are wasted to perform sequential operations. Another technique attempts to parallelize the sequential operations. However, this technique is difficult to implement and the parallelization may not be achieved completely.

### SUMMARY

One disclosed feature of the embodiments is a technique to decode a video frame. An entropy decoder performs entropy decoding on a bitstream of a video frame extracted from a network frame. The entropy decoder generates discrete cosine transform (DCT) coefficients representing a picture block in the video frame. The entropy decoder is configured for serial operations. A graphics processing unit (GPU) performs image decoding using the DCT coefficients. The GPU is configured for parallel operations.

One disclosed feature of the embodiments is a technique to decode a video frame. A GPU performs image encoding of a video frame computing quantized DCT coefficients representing a picture block in the video frame. The GPU is configured for parallel operations. An entropy encoder performs entropy encoding on the quantized DCT coefficients. The entropy encoder is configured for serial operations.

### BRIEF DESCRIPTION OF THE DRAWINGS

Embodiments may best be understood by referring to the following description and accompanying drawings that are used to illustrate embodiments of the invention. In the drawings.

FIG. 1 is a diagram illustrating a system according to one embodiment.

FIG. 2 is a diagram illustrating a real-time data processing system according to one embodiment.

FIG. 3 is a diagram illustrating a network processor according to one embodiment.

FIG. 4 is a diagram illustrating an entropy decoder according to one embodiment.

FIG. 5 is a diagram illustrating an entropy encoder according to one embodiment.

FIG. 6 is a diagram illustrating an image decoding unit according to one embodiment.

FIG. 7 is a diagram illustrating an image encoding unit according to one embodiment.

FIG. 8 is a flowchart illustrating a process to decode video frames according to one embodiment.

FIG. 9 is a flowchart illustrating a process to encode video frames according to one embodiment.

### DETAILED DESCRIPTION

One disclosed feature of the embodiments is a technique to decode a video frame. An entropy decoder performs entropy decoding on a bitstream of a video frame extracted from a network frame. The entropy decoder generates discrete cosine transform (DCT) coefficients representing a picture block in the video frame. The entropy decoder is configured for serial operations. A graphics processing unit (GPU) performs image decoding using the DCT coefficients. The GPU is configured for parallel operations.

One disclosed feature of the embodiments is a technique to decode a video frame. A GPU performs image encoding of a video frame computing quantized DCT coefficients representing a picture block in the video frame. The GPU is configured for parallel operations. An entropy encoder performs entropy encoding on the quantized DCT coefficients. The entropy encoder is configured for serial operations.

One disclosed feature of the embodiments is a technique to enhance video operations on video frames extracted from network frames by assigning serial operations to a serial processing device such as a field programmable gate array (FPGA) and parallel operations to a parallel processor such as a GPU. By allocating tasks to processors or devices that are best suited to handle the types of operations in the tasks, the system performance may be significantly improved for real-time processing. In addition, the decomposition of the operations into serial or sequential operations (e.g., entropy encoding/decoding) and parallel operations (e.g., image encoding/decoding) may lend the system to a pipeline architecture that provides a seamless flow of video processing. The use of the serial processing device located between the network processor and the GPU also alleviates the potential bottleneck at the interface between these two processors.

In the following description, numerous specific details are set forth. However, it is understood that embodiments of the invention may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

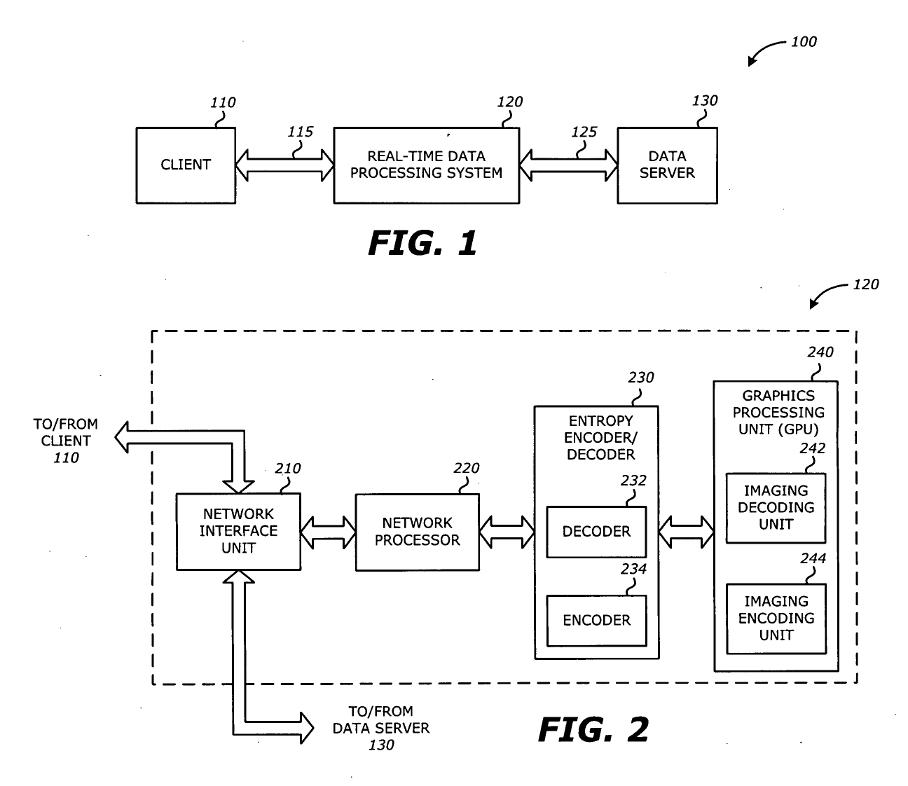

FIG. 1 is a diagram illustrating a system 100 according to one embodiment. The system 100 includes a client 110, a real-time data processing system 120, and a data server 130. It is noted that the system 100 may include more or less than the above components.

The client 110, the real-time data processing system 120, and the data server 130 communicate with each other via networks 115 and 125 or other communication media. The networks 115 and 125 may be wired or wireless. Examples of the networks 115 and 125 may be Local Area Network (LAN), Wide Area Network (WAN), Metropolitan Area Network (MAN). The networks 115 and 125 may be private or public. This may includes the Internet, an intranet, or an extranet, virtual LAN (VLAN), Asynchronous Transfer Mode (ATM). In one embodiment, the networks 115 and 125 use Ethernet technology. The network bandwidth may include 10 Mbps, 100 Mbps, 1 Gbps, or 10 Gbps. The network medium may be electrical or optical such as fiber optics. This may include passive optical network (PON), Gigabit PON, 10 Gigabit Ethernet PON, Synchronous optical network (SONET), etc. The network model or architecture may be client-server, peer-to-peer, or client-queue-client. The functions performed by the client 110, the real-time data processing system 120, and the data server 130 may be implemented by a set of software modules, hardware components, or a combination thereof.

The client 110 may be any client participating in the system 100. It may represent a device, a terminal, a computer, a hand-held device, a software architecture, a hardware component, or any combination thereof. The client 110 may use a Web browser to connect to the real-time data processing system 120 or the data server 130 via the network 115. The client 110 may upload or download files (e.g., multimedia, video, audio) to or from the real-time data processing system 120. The multimedia files may be any media files including media contents, video, audio, graphics, movies, documentary materials, business presentations, training materials, personal video clips, etc. In one embodiment, the client 110 downloads multimedia files or streams from the system 120.

The real-time data processing system 120 performs data processing on the streams transmitted on the networks 115 and/or 125. It may receive and/or transmit data frames such as video frames, or bitstreams representing the network frames such as the Internet Protocol (IP) frames. It may unpacketize, extract, or parse the bitstreams from the data server 130 to obtain relevant information, such as video frames. It may encapsulate processed video frames and transmit to the client 110. It may perform functions that are particular to the applications before transmit to the client 110. For example, it may re-compose the video content, insert additional information, apply overlays, etc.

The data server 130 may be any server that has sufficient storage and/or communication bandwidth to transmit or receive data over the networks 115 or 125. It may be a video server to deliver video on-line. It may store, archive, process, and transmit video streams with broadcast quality over the network 125 to the system 120.

FIG. 2 is a diagram illustrating the real-time data processing system 120 shown in FIG. 1 according to one embodiment. The system 120 includes a network interface unit 210, a network processor 220, an entropy encoder/decoder 230, and a graphics processing unit (GPU) 240. Note that more than one device for each type may be used. For example, there may be multiple network interface units or network processors, etc.

The network interface unit 210 provides interface to the client 110 and the data server 130. For example, it may receive the bitstreams representing network frames from the data server 130. It may transfer the recompressed video to the client 110.

The network processor 220 performs network-related functions. It may detect and extract video frames in the network frames. It may re-packetize or encapsulate the video frame for transmission to the client 110.

The entropy encoder/decoder 230 performs entropy encoding or decoding on the video bitstreams or frames. It may be a processor that is optimized for serial processing operations. Serial or sequential operations are operations that are difficult to execute in parallel. For example, there may be dependency between the data. In one embodiment, the entropy encoder/decoder 230 is implemented as a field programmable gate array (FPGA). It includes an entropy decoder 232 and an entropy encoder 234. The decoder 232 performs the entropy decoding on a bitstream of a video frame extracted from a network frame. It may generate discrete cosine transform (DCT) coefficients representing a picture block in the video frame. The DCT coefficients may then be forwarded or sent to the GPU for further decoding. The entropy encoder 234 may perform entropy encoding on the quantized DCT coefficients as provided by the GPU 240. It may be possible for the decoder 232 and the encoder 234 to operate in parallel. For example, the decoder 232 may decode a video frame k while the encoder 234 may encode a processed video frame k-1. The entropy decoder 232 and the entropy encoder 234 typically perform operations that are in reverse order of each other.

The GPU 240 is a processor that is optimized for graphics or image operations. It may also be optimized for parallel operations. Parallel operations are operations that may be performed in parallel. The GPU 240 may have a Single Instruction Multiple Data (SIMD) architecture where multiple processing elements may perform identical operations. The GPU 240 includes an image decoding unit 242 and an image encoding unit 244. The image decoding unit 242 may be coupled to the entropy decoder 232 in the entropy encoder/decoder 230 to perform image decoding operations such as inverse DCT, motion compensation. The image encoding unit 244 may be coupled to the entropy encoder 234 to perform image encoding of a video frame computing quantized discrete cosine transform (DCT) coefficients representing a picture block in the video frame.

Since entropy decoding/encoding is serial and image decoding/encoding is most suitable for parallel operations, assigning the entropy decoding/encoding tasks to a serial processing device (e.g., FPGA) and the image decoding/encoding tasks to a parallel processing device (e.g., the GPU) may exploit the best features of the devices and lead to an improved performance. In addition, since the entropy decoder/encoder and the GPU are separate and independent, their operations may be overlapped to form a pipeline architecture for video processing. This may lead to high throughput to accommodate real-time video processing.

Any of the network interface 210, the network processor 220, the entropy encoder/decoder 230, and GPU 240, or a portion of them may be a programmable processor that executes a program or a routine from an article of manufacture. The article of manufacture may include a machine storage medium that contains instructions that cause the respective processor to perform operations as described in the following.

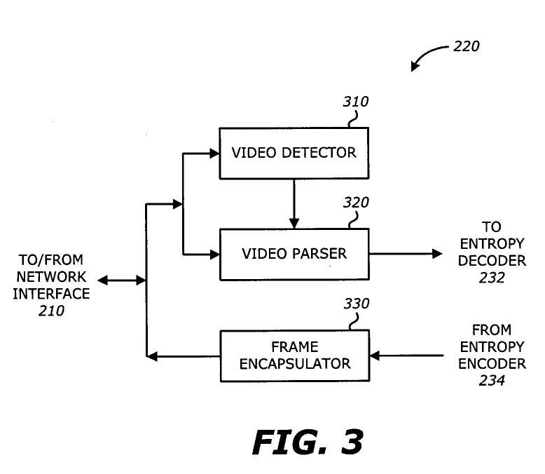

FIG. 3 is a diagram illustrating the network processor 220 according to one embodiment. The network processor 220 includes a video detector 310, a video parser 320, and a frame encapsulator 330. The network processor 220 may include more or less than above components. In addition, any of the components may be implemented by hardware, software, firmware, or any combination thereof.

The video detector 310 detects the video frame in the network frame. It may scan the bitstream representing the network frame and look for header information that indicates that a video frame is present in the bitstream. If the video is present, it instructs the video parser 320 to extract the video frame.

The video parser 320 parses the network frame into the video frame once the video is detected in the bitstream. The parsed video frame is then forwarded to the entropy decoder 232.

The frame encapsulator 330 encapsulates the encoded video frame into a network frame according to appropriate format or standard. This may include packetization of the video frame into packets, insertion of header information into the packets, or any other necessary operations for the transmission of the video frames over the networks 115 or 125.

The video detector 310, the video parser 320, and the frame encapsulator 330 may operate in parallel. For example, the video detector 310 and the video parser 320 may operate on the network frame k while the frame encapsulator 330 may operate on the network frame k-1.

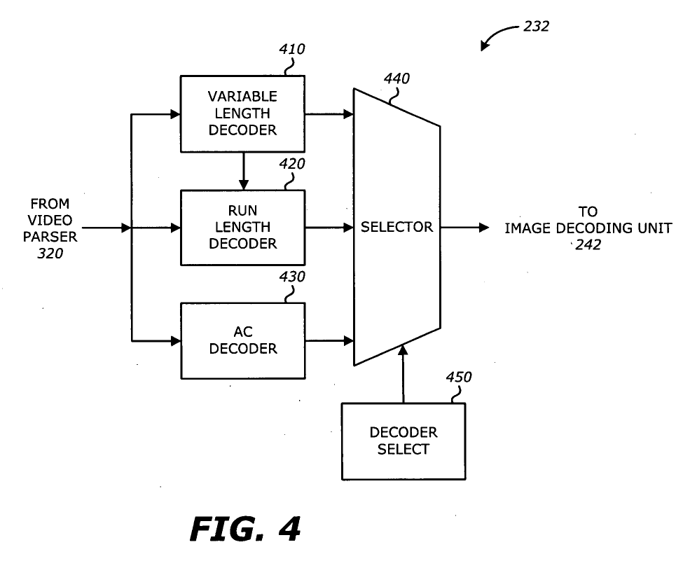

FIG. 4 is a diagram illustrating the entropy decoder 232 shown in FIG. 2 according to one embodiment. The entropy decoder 232 includes a variable length decoder (VLD) 410, a run-length decoder (RLD) 420, an arithmetic coding (AC) decoder 430, a selector 440, and a decoder select 450. Note that the decoder 232 may include more or less than the above components. For example, the RLD 420 may not be needed if the video stream is not encoded with run length encoding. The decoder 232 includes decoders that may perform decoding according to a number of video standards or formats. In one embodiment, the entropy decoding is compatible with at least one of an MPEG-2 standard and an H.264 standard.

The VLD 410 performs a variable length decoding on the bitstream. In one embodiment, the Huffman decoding procedure is used. In another embodiment, the VLD 410 may implement a context-adaptive variable length coding (CAVLC) decoding. The VLD 410 is used mainly for the video frames that are encoded using the MPEG-2 standard. The RLD 420 performs a run length decoding on the bitstream. The RLD 420 may be optional. The VLD 410 and the RLD 420 insert redundant information in the video frames. The variable length decoding and the run length encoding are mainly sequential tasks. The output of the VLD 410 is a run-level pair and its code length. The VLD 410 generates the output code according to predetermined look-up tables (e.g., the B12, B13, B14, and B15 in MPEG-2).

The AC decoder 430 performs an AC decoding on the bitstream. In one embodiment, the AC decoding is a context-based adaptive binary arithmetic coding (CABAC) decoding. The AC decoder 430 is mainly used for video frames that are encoded using AC such as the H.264 standard. The AC decoding is essentially sequential and includes calculations of range, offset, and context variables.

The selector 440 selects the result of the entropy decoders and sends it to the image decoding unit 242. It may be a multiplexer or a data selector. The decoder select 450 provides control bits to control the selector according to the detected format of the video frames.

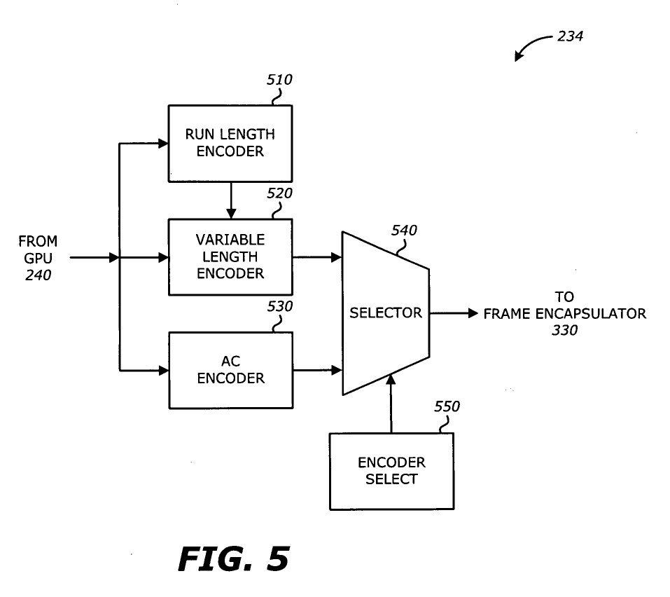

FIG. 5 is a diagram illustrating the entropy encoder 234 shown in FIG. 2 according to one embodiment. The entropy encoder 234 includes a run length encoder (RLE) 510, a variable length encoder (VLE) 520, an AC encoder 530, a selector 540, and an encoder select 550. Note that the encoder 234 may include more or less than the above components. For example, the RLE 510 may not be needed if the video stream is not encoded with run length encoding. The encoder 234 includes encoders that may perform encoding according to a number of video standards or formats. In one embodiment, the entropy encoding is compatible with at least one of an MPEG-2 standard and an H.264 standard.

The RLE 510 performs a run length encoding on the quantized DCT coefficients. The VLE 520 performs a variable length encoding on the quantized DCT coefficients. In one embodiment, the variable length encoding is the Huffman encoding. In another embodiment, the VLE 520 may implement a context-adaptive variable length coding (CAVLC) encoding. The RLE 510 may be optional. When the RLE 510 and VLE 520 are used together, the RLE 510 typically precedes the VLE 520. The RLE 510 generates the run-level pairs that are Huffman coded by the VLE 520. The VLE 520 generates from the frequently occurring run-level pairs a Huffman code according to predetermined coding tables (e.g., the B12, B13, B14, and B15 coding tables in the MPEG-2). The AC encoder 530 performs an AC encoding on the quantized DCT coefficients. The AC encoder 530 is used when the video compression standard is the H.264 standard. In one embodiment, the AC encoder 530 implements the CABAC encoding.

The selector 540 selects the result of the encoding from the VLE 520 or the CABAC encoder 530. The selected result is then forwarded to the frame encapsulator 330. The encoder select 550 generates control bits to select the encoding result.

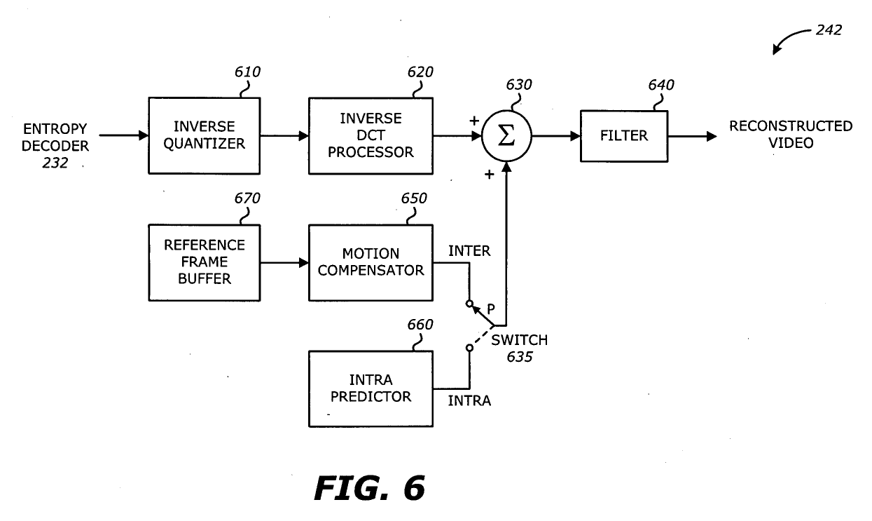

FIG. 6 is a diagram illustrating the image decoding unit 242 shown in FIG. 2 according to one embodiment. The image decoding unit 242 includes an inverse quantizer 610, an inverse DCT processor 620, an adder 630, a filter 640, a motion compensator 650, an intra predictor 660, and a reference frame buffer 670. Note that the image decoding unit 242 may include more or less than the above components.

The inverse quantizer 610 computes the inverse of the quantization of the discrete DCT coefficients. The inverse DCT processor 620 calculates the inverse of the DCT coefficients to recover the original spatial domain picture data. The adder 630 adds the output of the inverse DCT processor 620 to the predicted inter- or intra-frame to reconstruct the video. The filter 640 filters the output of the adder 630 to remove blocking artifacts to provide the reconstructed video. The reference frame buffer 670 stores one or more video frames. The motion compensator 650 calculates the compensation for the motion in the video frames to provide P macroblocks using the reference frames from the reference frame buffer 670. The intra predictor 660 performs intra-frame prediction. A switch 635 is used to switch between the inter-frame and intra-frame predictions or codings. The result of the image decoder is a decompressed or reconstructed video. The decompressed or reconstructed video is then processed further according to the configuration of the system.

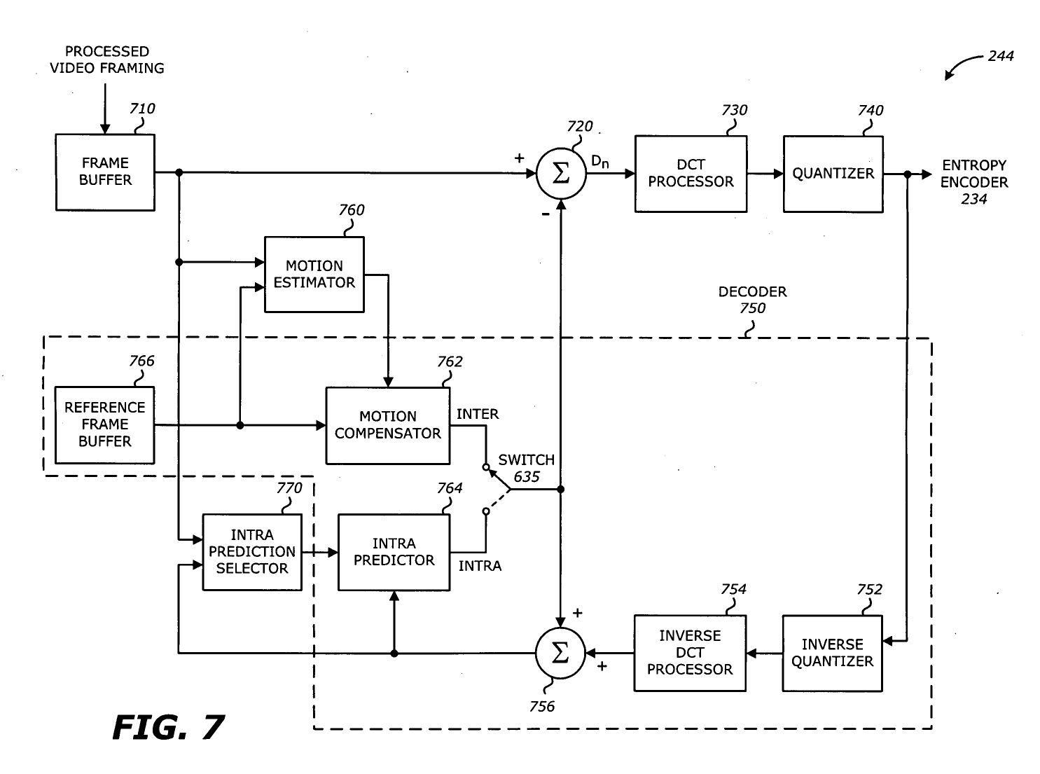

FIG. 7 is a diagram illustrating the image encoding unit 244 shown in FIG. 2 according to one embodiment. The image encoding unit 244 includes a frame buffer 710, a subtractor 720, a DCT processor 730, a quantizer 740, a decoder 750, a motion estimator 760, and an intra-prediction selector 770. Note that the image decoding unit 242 may include more or less than the above components.

The frame buffer 710 buffers the video frames. The subtractor 720 subtracts the predicted inter- or intra-frame macroblock P to produce a residual or difference macroblock. The DCT processor 730 computes the DCT coefficients of the residual or difference blocks in the video frames. The quantizer 740 quantizes the DCT coefficients and forwards the quantized DCT coefficients to the entropy encoder 234. The decoder 750 essentially is identical to the decoding unit 242 shown in FIG. 6. The decoder 750 includes an inverse quantizer 752, and inverse DCT processor 754, an adder 756, a motion compensator 762, an intra predictor 764, a switch 763, and a reference frame buffer 766. The components are similar to the corresponding components as described in FIG. 6. This is to ensure that both the encoding unit 244 and the decoding unit 242 use identical reference frames to create the prediction P to avoid drift error between the encoding unit and the decoding unit. The motion estimator 760 performs motion estimation of the macroblocks in the video frames and provide the estimated motion to the motion compensator 762 in the decoder 750. The intra prediction selector 770 chooses the intra-frame prediction modes for the intra predictor 764 in the decoder 750.

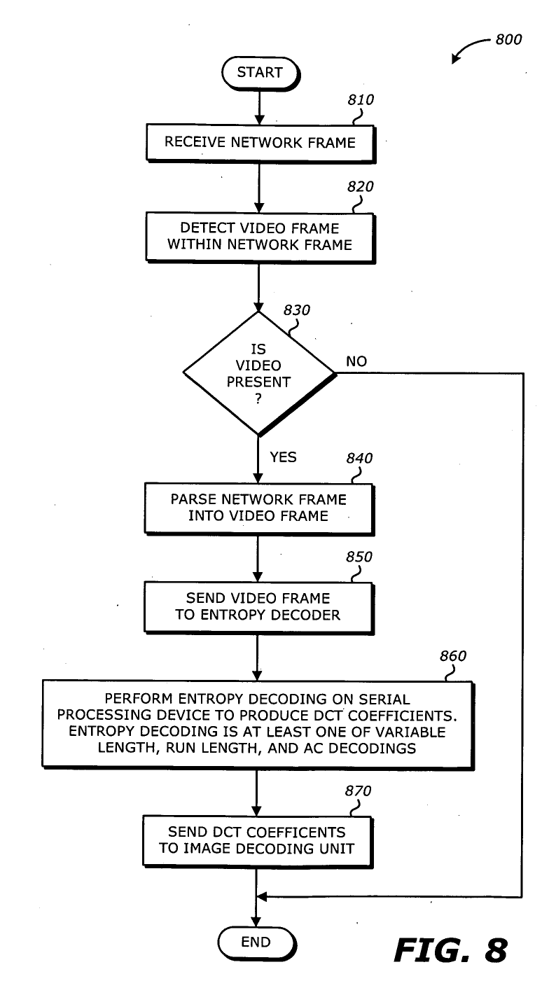

FIG. 8 is a flowchart illustrating a process 800 to decode video frames according to one embodiment.

Upon START, the process 800 receives the network frame (Block 810) as provided by the network interface unit 210 shown in FIG. 2. The network frame may be an Ethernet frame, or any frame that is compatible with the configuration of the network. Next, the process 800 detects a video frame in the network frame (Block 820). This may be performed by scanning the video frame and looking for header information that indicates that the frame is a video frame.

Then, the process 800 determines if the video information is present (Block 830). If not, the process 800 is terminated. Otherwise, the process 800 parses the network frame into a video frame (Block 840). This may involve stripping off unimportant header data, obtaining the attributes (e.g., compression type, resolution) of the video frame, etc. Next, the process 800 sends the parsed video frame to the entropy encoder (Block 850).

Then, the process 800 performs entropy encoding on a serial processing device (e.g., FPGA) to produce the DCT coefficients representing the video frame (Block 860). The entropy decoding is at least one of a variable length decoding (e.g., Huffman decoding, CAVLC decoding), a run length decoding, and an AC decoding (e.g., CABAC decoding) (Block 860).

Next, the process 800 sends the DCT coefficients to the image decoding unit in the GPU (Block 870). The image decoding unit then carries out the image decoding tasks (e.g., inverse DCT, motion compensation). The process 800 is then terminated.

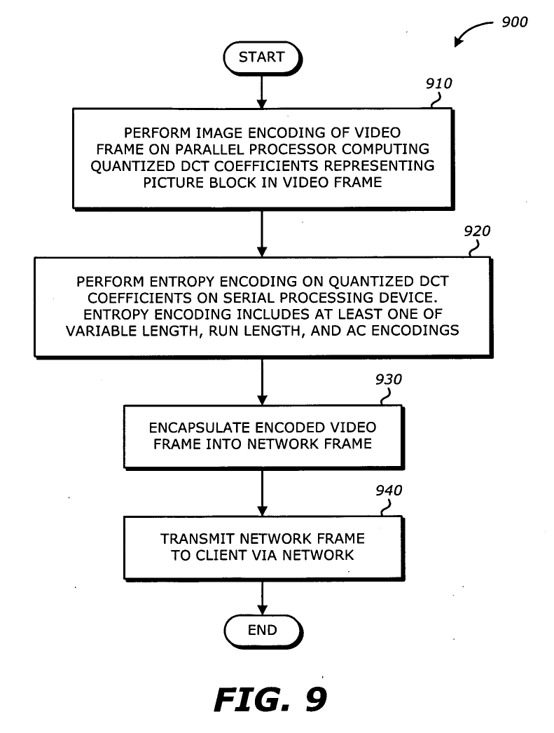

FIG. 9 is a flowchart illustrating the process 900 to encode video frames according to one embodiment.

Upon START, the process 900 performs image encoding of the video frame on a parallel processor computing quantized DCT coefficients which represent a picture block in the video frame (Block 910). The video frame may be processed separately by a video processor or by a video processing module in the GPU. Next, the process 900 performs entropy encoding on the quantized DCT coefficients on a serial processing device (e.g., FPGA) (Block 920). The entropy encoding may include at least one of a variable length encoding (e.g., Huffman encoding, CAVLC encoding), a run length encoding, and an AC encoding (e.g., CABAC encoding) depending on the desired compression standard (Block 920). The process 900 also incorporates decoding operations as described above.

Then, the process 900 encapsulates the encoded video frame into a network frame (e.g., Ethernet frame) (Block 930). Next, the process 900 transmits the network frame to the client via the network (Block 940). The process 900 is then terminated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment are essentially the code segments to perform the necessary tasks. The software/firmware may include the actual code to carry out the operations described in one embodiment, or code that emulates or simulates the operations.

The program or code segments can be stored in a processor or machine accessible medium. The “processor readable or accessible medium” or “machine readable or accessible medium” may include any medium that may store, transmit, receive, or transfer information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus comprising:
an entropy decoder to perform entropy decoding on a bitstream of a video frame extracted from a network frame, the entropy decoder generating discrete cosine transform (DCT) coefficients representing a picture block in the video frame, the entropy decoder being configured for serial operations; and
a graphics processing unit (GPU) coupled to the entropy decoder to perform image decoding using the DCT coefficients, the GPU being configured for parallel operations.

2. The apparatus of claim 1 wherein the entropy decoder comprises a variable length decoder to perform a variable length decoding on the bitstream.

3. The apparatus of claim 2 wherein the entropy decoder further comprises a run length decoder to perform a run length decoding on the bitstream.

4. The apparatus of claim 1 wherein the entropy decoder is implemented using a field programmable gate array (FPGA).

5. The apparatus of claim 4 wherein the entropy decoder comprises an arithmetic coding (AC) decoder to perform an AC decoding on the bitstream.

6. The apparatus of claim 1 wherein the entropy decoding is compatible with at least one of an MPEG-2 standard and an H.264 standard.

7. The apparatus of claim 1 wherein the GPU performs at least one of an inverse quantization, an inverse DCT, a video reconstruction, a filtering, and an inter- or intra-frame prediction.

8. The apparatus of claim 1 wherein the image decoding is compatible with at least one of an MPEG-2 standard and an H.264 standard.

9. The apparatus of claim 1 wherein the network frame is an Ethernet frame.

10. The apparatus of claim 1 further comprising:
a network interface unit to receive the network frame from a data server via a network; and
a network processor coupled to the network interface unit to extract the video frame from the network frame.

11. The apparatus of claim 10 wherein the network processor comprises:
a video detector to detect the video frame in the network frame; and
a video parser coupled to the video detector to parse the network frame into the video frame.

12. An apparatus comprising:
a graphics processing unit (GPU) to perform image encoding of a video frame computing quantized discrete cosine transform (DCT) coefficients representing a picture block in the video frame, the GPU being configured for parallel operations; and
an entropy encoder coupled to GPU to perform entropy encoding on the quantized DCT coefficients, the entropy encoder being configured for serial operations.

13. The apparatus of claim 12 wherein the entropy encoder comprises a variable length encoder to perform a variable length encoding on the quantized DCT coefficients.

14. The apparatus of claim 13 wherein the entropy encoder further comprises a run length encoder to perform a run length encoding on the quantized DCT coefficients.

15. The apparatus of claim 12 wherein the entropy encoder is implemented using a field programmable gate array (FPGA).

16. The apparatus of claim 15 wherein the entropy encoder comprises an arithmetic coding (AC) encoder to perform an AC encoding on the quantized DCT coefficients.

17. The apparatus of claim 12 wherein the entropy encoding is compatible with at least one of an MPEG-2 standard and an H.264 standard.

18. The apparatus of claim 12 wherein the GPU performs at least one of an residual computation, a DCT, a quantization on the DCT coefficients, and a decoding.

19. The apparatus of claim 12 wherein the image encoding is compatible with at least one of an MPEG-2 standard and an H.264 standard.

20. The apparatus of claim 12 further comprising:
a network processor coupled to the entropy encoder to encapsulate the encoded video frame into a network frame; and
a network interface unit to transmit the network frame to a client via a network.

21. The apparatus of claim 20 wherein the network frame is an Ethernet frame.

22. A method comprising:
performing entropy decoding, on a serial processing device, on a bitstream of a video frame extracted from a network frame to generate discrete cosine transform (DCT) coefficients representing a picture block in the video frame; and
performing image decoding of the video frame using the DCT coefficients on a parallel processing device.

23. The method of claim 22 wherein performing entropy decoding comprises performing at least one of a variable length decoding, a run length decoding, and an arithmetic coding (AC) decoding on the bitstream.

24. The method of claim 22 further comprising:
receiving the network frame from a data server via a network; and
extracting the video frame from the network frame.

25. The method of claim 24 wherein extracting the video frame comprises:
detecting the video frame in the network frame; and
parsing the network frame into the video frame.

26. The method of claim 22 wherein the serial processing device is a field programmable gate array (FPGA).

27. The method of claim 22 wherein the entropy decoding is compatible with at least one of an MPEG-2 standard and an H.264 standard.

28. A method comprising:
performing image encoding of a video frame on a parallel processor computing quantized discrete cosine transform (DCT) coefficients representing a picture block in the video frame; and
performing entropy encoding of the quantized DCT coefficients on a serial processing device.

29. The method of claim 28 wherein performing entropy encoding comprises performing at least one of a variable length encoding, a run length encoding, and an arithmetic coding (AC) encoding on the quantized DCT coefficients.

30. The method of claim 29 further comprising:
encapsulating the encoded video frame into a network frame; and
transmitting the network frame to a client via a network.

31. The method of claim 28 wherein the serial processing device is a field programmable gate array (FPGA).

32. The method of claim 28 wherein the entropy decoding is compatible with at least one of an MPEG-2 standard and an H.264 standard.
